(19) United States
(12) Patent Application Publication
(10) Pub. No.: US 2016/0067902 A1
(43) Pub. Date: Mar. 10, 2016

(54) EXTRUSION DIE FOR PRODUCING BICOLOR PLASTIC SHEETS

(71) Applicant: CHING HSING IRON WORKS CO., LTD., New Taipei City (TW)

(72) Inventor: Chien Yuan LIN, New Taipei City (TW)

(21) Appl. No.: 14/479,106

(22) Filed: Sep. 5, 2014

(51) Int. Cl. B29C 47/08

(52) U.S. Cl. CPC B29C 47/0828

(57) ABSTRACT

An extrusion die includes a first metal plate and a second metal plate. The first and second metal plates define a first entrance for receiving a first plastic flow, a first cavity including two first distributing channels, and a second cavity including two second distributing channels. The first entrance communicates with the first cavity. The first metal plate further defines a second entrance for receiving a second plastic flow of different color. The second entrance communicates with the second cavity. The first cavity communicates with the second cavity through a common side therebetween. An exit is defined at bottoms of the cavities, from which bicolor plastic sheets can be delivered. One of the first distributing channels and one of the second distributing channels are respectively curved downwardly to join to the common side between the cavities, so that the plastic flows can flow more smoothly to prevent color mixing therebetween.

### TECHNICAL FIELD OF THE INVENTION

The present invention relates to an extrusion die and, more particularly, to an extrusion die that can produce bicolor plastic sheets or films.

### DESCRIPTION OF THE PRIOR ART

In everyday life, plastic boxes are usually employed to accommodate fruits, foods, or other articles, so as to protect those objects and provide an aesthetic appearance. For transparent plastic boxes, although the surfaces can be imprinted with colored layers, patterns or texts, or attached with tags to prevent the contents therein to be shown up directly, these ways for hiding the contents of the plastic boxes will increase manufacturing steps and the cost. Besides, the colored layers, patterns, and texts are easy to flake off. Thus, it is deserved for the associated professionals to consider a different manufacturing process that can more easily produce a bicolor plastic box, which may include both of transparent and opaque portions, or may include both of deep-color and light-color portions, so as to solve the above problem.

Currently, for making plastic sheets, a molten plastic flow, which is usually obtained by heating plastic pellets, is delivered from an extruder to enter a die that has a wide, flat shape for producing plastic sheets, which then can be further processed for making plastic boxes. However, prior-art extrusion dies can only produce single-color plastic sheets, and consequently only single-color plastic boxes can be produced.

For solving the shortcomings and inconvenience of prior-art extrusion dies, based on long-term experiences of developing plastic products and numerous tests, the applicant has contrived an improved extrusion die.

### SUMMARY OF THE INVENTION

One object of the present invention is to provide an extrusion die that can produce bicolor plastic sheets or films.

To accomplish the above object, the present invention provides an extrusion die, which comprises a first metal plate and a second metal plate. The first and second metal plates define a first entrance for receiving a first plastic flow from an extruder, a first cavity including two first distributing channels at its top, and a second cavity including two second distributing channels at its top. The first entrance communicates with the first cavity through the two first distributing channels. The first metal plate further defines a second entrance for receiving a second plastic flow, with a different color than the first plastic flow, from an extruder, wherein the second entrance communicates with the second cavity through the two second distributing channels. The first and second cavities are arranged along the width of the two metal plates and aligned with each other, such that the first cavity abuts the second cavity and communicates with the second cavity through a common side therebetween. An exit is defined at bottoms of the first and second cavities, between the first and second metal plates, from which a bicolor plastic sheet or film having two zones can be delivered, each zone corresponding to one of the cavities. One of the first distributing channels and one of the second distributing channels are respectively curved downwardly to join to a top portion of the common side between the first and second cavities, so that the plastic flows can be guided to flow more smoothly towards the exit to prevent color mixing therebetween.

Furthermore, the first and second plastic flows being supplied for the extrusion die are PET.

In the extrusion die, the first entrance communicates with the first cavity through a guiding channel being connected with the two first distributing channels.

In the extrusion die, the first distributing channels are symmetrical about a longitudinal central line of the first cavity, and the diameter of each distributing channel is greater than the depth of other parts of the first cavity.

Furthermore, in the extrusion die, the first cavity is shaped like a bell.

In the extrusion die, the second distributing channels are symmetrical about a longitudinal central line of the second cavity, and the diameter of each distributing channel is greater than the depth of other parts of the second cavity.

Furthermore, in the extrusion die, the second cavity is shaped like a bell.

In the extrusion die, the first and second metal plates further define a first buffering space across the first and second cavities, located downstream of the first and second distributing channels and upstream of the exit.

Furthermore, in the extrusion die, the first buffering space has a curved cross-section.

In the extrusion die, the first and second metal plates further define two second buffering spaces across the first and second cavities, wherein one of the second buffering spaces is located upstream of the first buffering space and downstream of the first and second distributing channels; the other of the second buffering spaces is located downstream of the first buffering space and upstream of the exit.

In operation, the two plastic flows of different colors can respectively enter the first entrance and the second entrance, and then enter the first cavity and the second cavity. Also, the sharp angle, which is formed by two downwardly curved segments of the distributing channels, can guide the two plastic flows to flow towards the exit more smoothly and quickly, so that color mixing between the plastic flows can be prevented, and thus a bicolor plastic sheet or film with a clear boundary can be delivered from the exit. Thereafter, the bicolor plastic sheet or film can be further processed for making a bicolor plastic box, to overcome the shortcomings of the existing extrusion die that can only produce single-color plastic sheets or films.

Other objects, advantages, and novel features of the present invention will become more apparent from the following detailed description when taken in conjunction with the accompanying drawings.

### BRIEF DESCRIPTION OF THE DRAWINGS

FIG. 1 shows an exploded view of an extrusion die according to one embodiment of the present invention.

FIG. 2 shows a 3-dimensional view of the extrusion die of the embodiment of the present invention.

FIG. 3 shows a schematic front working view of the embodiment of the present invention, wherein a plastic sheet or film is delivered from the exit of the extrusion die.

FIG. 4 shows a schematic side working view of the embodiment of the present invention, wherein a plastic sheet or film is delivered from the exit of the extrusion die.

FIG. 5 shows an enlarged partial view of the embodiment of the present invention.

### DETAILED DESCRIPTION OF THE PREFERRED EMBODIMENTS

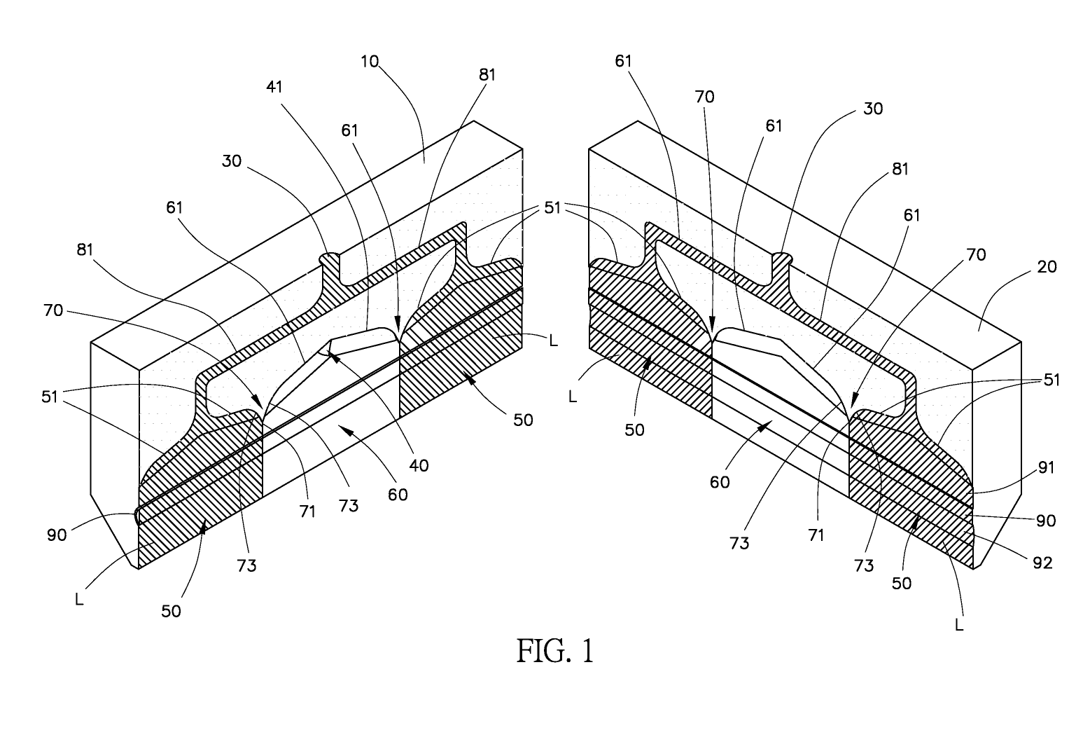

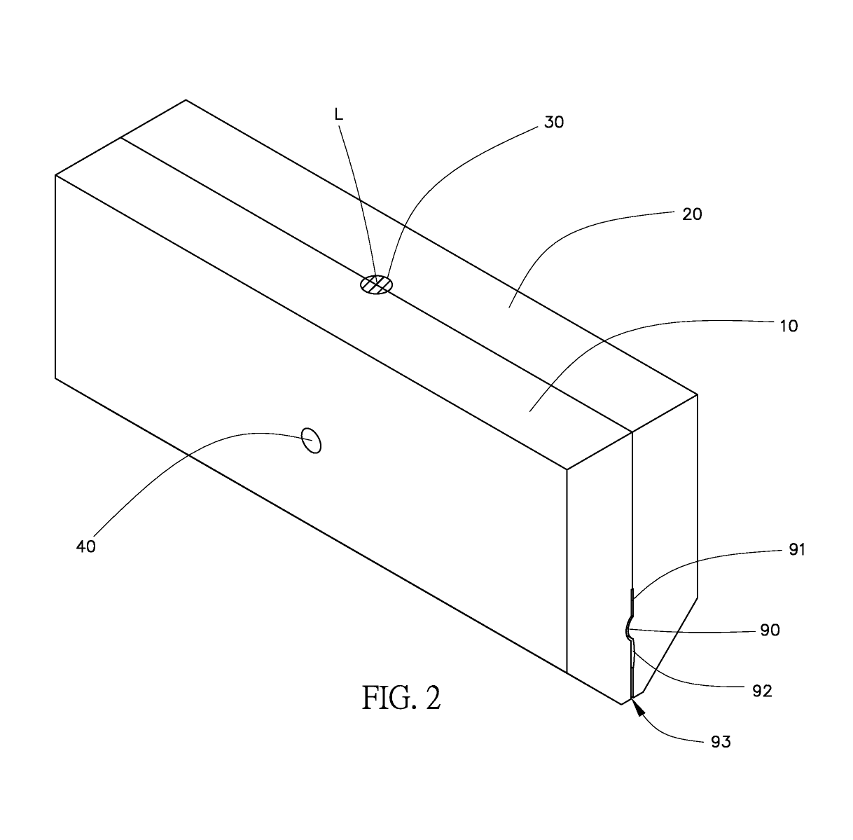

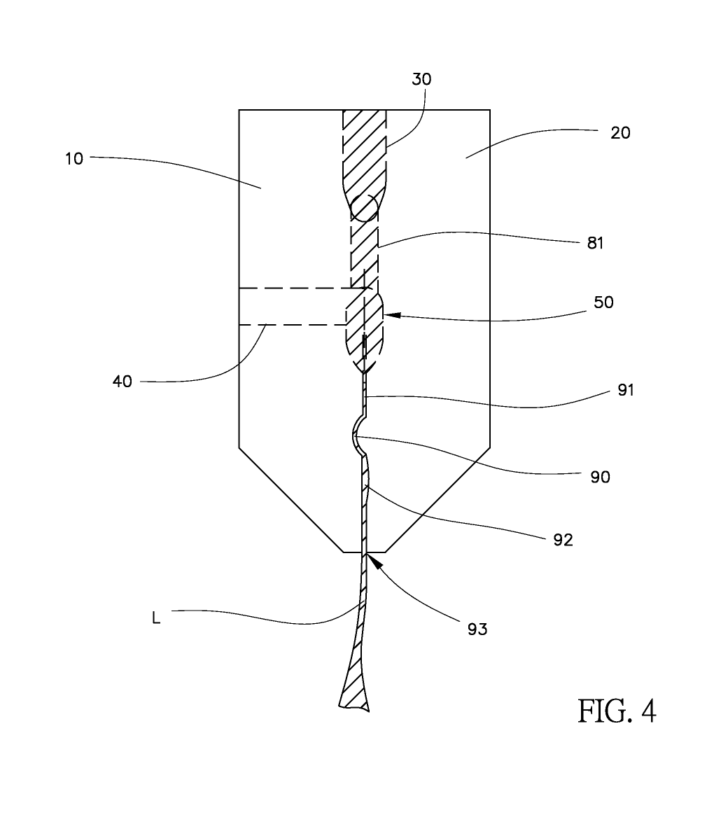

Referring to FIGS. 1 through 4, an extrusion die according to one embodiment of the present invention is shown, which comprises a first metal plate 10 and a second metal plate 20.

The first metal plate 10 defines a plurality of first recesses on one surface thereof. The second metal plate 20 defines a plurality of second recesses on one surface thereof corresponding to the first recesses. The first and second recesses are combined to form a first entrance 30 for receiving a first plastic flow from an extruder (not shown), two first cavities 50 each including two first distributing channels 51 at its top, and a second cavity 60 including two second distributing channels 61 at its top, wherein all the cavities are arranged along the width of the first and second metal plates 10, 20 (the width is the distance between the left and right sides of the extrusion die) and aligned with each other; the second cavities 60 is located between the two first cavities 50; the left first cavity 50 abuts the second cavity 60 and communicates with the second cavity 60 through a common side therebetween; the right cavity 50 also abuts the second cavity 60 and communicates with the second cavity 60 through a common side therebetween. The first entrance 30 communicates with the two first cavities 50 through the corresponding two first distributing channels 51.

The first metal plate 10 further defines a second entrance 40 for receiving a second plastic flow, with a different color than the first plastic flow, from an extruder (not shown), wherein the second entrance 40 communicates with the second cavity 60 through the two second distributing channels 61.

Furthermore, an exit 93 is defined at bottoms of the first and second cavities 50, 60, between the first and second metal plates 10, 20, from which a bicolor plastic sheet having three zones can be delivered, each zone corresponding to one of the three cavities 50, 60.

Furthermore, one of the first distributing channels 51 and one of the second distributing channels 61 are respectively curved downwardly to join to a top portion 71 of the common side between the adjacent first and second cavities 50, 60, so that the plastic flows can be guided to flow towards the exit 93 more smoothly and quickly to prevent color mixing between the adjacent cavities, so that the boundary between the two plastic flows will become more clear. As shown, the two downwardly curved segments 73 of the distributing channels 51, 61 are joined to the top portion 71 of the common side between the adjacent cavities to form a sharp angle 70.

In operation, the extruders (not shown) can deliver two plastic flows of different colors (such as transparent and opaque plastic flows), which can be a molten plastic through heating, to respectively enter the first entrance 30 and the second entrance 40, and then enter the first cavities 50 and the second cavity 60, wherein the first plastic flow (L) is indicated by oblique section lines. As mentioned above, the sharp angle 70, which is formed by two downwardly curved segments 73, can guide the two plastic flows to flow towards the exit 93 more smoothly and quickly, so that the two plastic flows can be thermally bonded along the common side therebetween, but color mixing between the plastic flows can be prevented. Since the temperature of the plastic flows will be gradually decreased to become a solid state while they are forced to pass through the cavities 50, 60, a bicolor plastic sheet or film (such as a plastic sheet with transparent and opaque portions) having three zones can be delivered from the exit 93, wherein the color of the middle zone corresponding to the second cavity 60 is different from the color of the lateral zones corresponding to the first cavities 50, and the boundaries between the three zones will be clear. Thereafter, the plastic sheet can be further processed to make a bicolor plastic box, to overcome the shortcomings of the existing extrusion die that can only produce single-color plastic sheets.

In the embodiment, the plastic flows can be obtained by heating pellets of PET (Polyethylene terephthalate) in extruders. For example, the two plastic flows used in the embodiment can be transparent plastic flow and opaque plastic flow, deep-color plastic flow and light-color plastic flow, or plastic flows of other colors.

Furthermore, in the embodiment, the entrance 30 communicates with the first cavities 50 through a guiding channel 81 being connected with the first distributing channels 51.

Preferably, the two first cavities 50, each of which includes two first distributing channels 51, are designed such that each distributing channel 51 has an diameter greater than the depth of other parts of the first cavity 50, so that the first plastic flow can be guided to flow towards the exit 93 more smoothly and quickly. Also, in the embodiment, the two first distributing channels 51 in each first cavity 50 are symmetrical about a longitudinal central line of the first cavity 50. As shown, since the first distributing channels 51 of each first cavity 50 are curved downwardly to joined to the top portions of the opposite sides of the first cavity 50, each first cavity 50 is shaped like a bell, and this can facilitate the first plastic flow to flow towards the exit 93, thereby preventing color mixing between the plastic flows and thus creating clear boundaries.

Preferably, the second cavity 60, which includes two second distributing channels 61, is designed such that each distributing channel 61 has a diameter greater than the depth of other parts of the second cavity 60, so that the second plastic flow can be guided to flow towards the exit 93 more smoothly and quickly. Also, in the embodiment, the two second distributing channels 61 are symmetrical about a longitudinal central line of the second cavity 60. As shown, since the second distributing channels 61 of the second cavity 60 are curved downwardly to joined to the top portions of the opposite sides of the second cavity 60, the second cavity 60 is shaped like a bell, and this can facilitate the second plastic flow to flow towards the exit 93, thereby preventing color mixing between the plastic flows and thus creating clear boundaries.

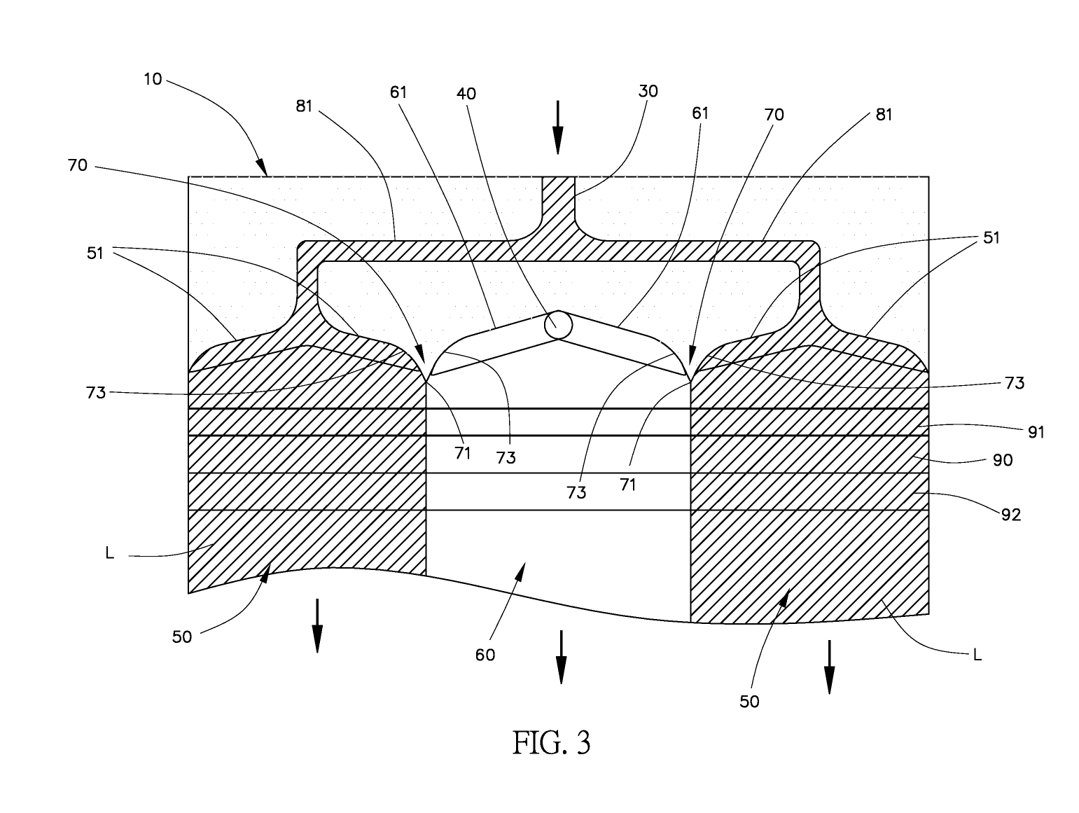

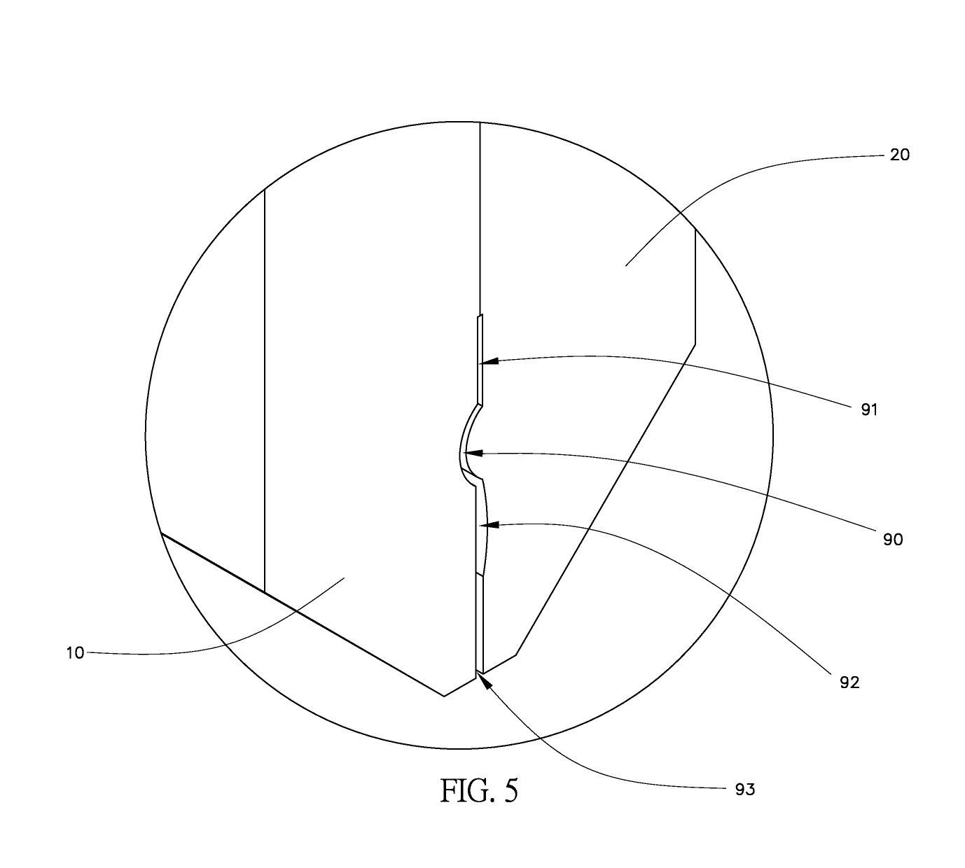

As shown in FIGS. 3, 4 and 5, in the embodiment, the first and second metal plates 10, 20 further define a first buffering space 90 across the first and second cavities 50, 60, located downstream of the first and second distributing channels 51, 61 while upstream of the exit 93. Preferably, the first buffering space 90 has a curved cross-section. The first buffering space 90 can increase the flowing path of the plastic flows, so that the time of the plastic flows retained in the first and second cavities 50, 60 can be increased, so that the speed and pressure of the plastic flows can become more uniform, so that incomplete shaping of plastic flow can be avoided, so that the plastic sheets or films delivered from the exit 93 can be more uniform and have a good appearance.

In the embodiment, for improving the buffering effect, the first and second metal plates 10, 20 further defines two second buffering spaces 91, 92 across the first and second cavities 50, 60, wherein the second buffering space 91 is located upstream of the first buffering space 90 and downstream of the first and second distributing channels 51, 61; the second buffering space 92 is located downstream of the first buffering space 90 and upstream of the exit 93.

As a summary, the present invention employs multiple entrances and multiple communicable cavities arranged along the width of the extrusion die, wherein the distributing channels are curved downwardly to join to the common sides between cavities to show as sharp angles, so that the plastic flows of different colors can be guided to flow towards the exit of the extrusion die more smoothly and quickly, so that color mixing between the plastic flows can be prevented, thereby producing bicolor plastic sheets or films with clear boundaries.

In view of the embodiment of the present invention, persons skilled in the art can make an extrusion die that produces bicolor plastic sheets or films having multiple zones with clear boundaries therebetween.

Although the present invention has been described with a certain degree of particularity, it is understood that the present disclosure is made by way of example only and the combination and arrangement of parts may be resorted to without departing from the spirit and scope of the invention hereinafter claimed.

I claim:

1. An extrusion die, comprising
a first metal plate defining a plurality of first recesses on one surface thereof; and
a second metal plate defining a plurality of second recesses on one surface thereof corresponding to the first recesses;
wherein the first and second recesses are combined to form a first entrance for receiving a first plastic flow from an extruder, a first cavity including two first distributing channels at its top, and a second cavity including two second distributing channels at its top; the first entrance communicates with the first cavity through the two first distributing channels; the first metal plate further defines a second entrance for receiving a second plastic flow, with a different color than the first plastic flow, from an extruder, the second entrance communicating with the second cavity through the two second distributing channels; the first and second cavities are arranged along the width of the two metal plates and aligned with each other, such that the first cavity abuts the second cavity and communicates with the second cavity through a common side therebetween; an exit is defined at bottoms of the first and second cavities, between the first and second metal plates, from which a bicolor plastic sheet or film having two zones is delivered, each zone corresponding to one of the cavities; and
wherein one of the first distributing channels and one of the second distributing channels are respectively curved downwardly to join to a top portion of the common side between the first and second cavities, so that the plastic flows will flow towards the exit more smoothly so as to prevent color mixing therebetween.

2. The extrusion die of claim 1, wherein the first and second plastic flows are PET.

3. The extrusion die of claim 1, wherein the first and second metal plates further define therebetween a third cavity including two third distributing channels at its top, wherein the third cavity is arranged along the width of the first and second metal plates, in alignment with the first and second cavities, such that the third cavity abuts the second cavity and communicates with the second cavity by a common side therebetween; the first entrance communicates with the third cavity through the third distributing channels; one of the third distributing channel and the other of the second distributing channels are respectively curved downwardly to join to a top portion of the common side between the second and third cavities, so that the plastic flows will flow towards the exit more smoothly so as to prevent color mixing therebetween; whereby a bicolor plastic sheet or film having three zones is delivered from the exit, each zone corresponding to one of the cavities.

4. The extrusion die of claim 1, wherein the first entrance communicates with the first cavity through a guiding channel being connected with the two first distributing channels.

5. The extrusion die of claim 3, wherein the first entrance communicates with the first cavity and the third cavity through a guiding channel being connected with the two first distributing channels and the two third distributing channels.

6. The extrusion die of claim 1, wherein the first distributing channels are symmetrical about a longitudinal central line of the first cavity, and the diameter of each distributing channel is greater than the depth of other parts of the first cavity.

7. The extrusion die of claim 6, wherein the first cavity is shaped like a bell.

8. The extrusion die of claim 1, wherein the second distributing channels are symmetrical about a longitudinal central line of the second cavity, and the diameter of each distributing channel is greater than the depth of other parts of the second cavity.

9. The extrusion die of claim 8, wherein the second cavity is shaped like a bell.

10. The extrusion die of claim 3, wherein the third distributing channels are symmetrical about a longitudinal central line of the third cavity, and the diameter of each distributing channel is greater than the depth of other parts of the third cavity.

11. The extrusion die of claim 10, wherein the third cavity is shaped like a bell.

12. The extrusion die of claim 1, wherein the first and second metal plates further define a first buffering space across the first and second cavities, located downstream of the first and second distributing channels and upstream of the exit.

13. The extrusion die of claim 12, wherein the first buffering space has a curved cross-section.

14. The extrusion die of claim 13, wherein the first and second metal plates further define two second buffering spaces across the first and second cavities, wherein one of the second buffering spaces is located upstream of the first buffering space and downstream of the first and second distributing channels; the other of the second buffering spaces is located downstream of the first buffering space and upstream of the exit.

15. The extrusion die of claim 3, wherein the first and second metal plates further define a first buffering space across the first and second and third cavities, located downstream of the first and second and third distributing channels and upstream of the exit.

16. The extrusion die of claim 15, wherein the first buffering space has a curved cross-section

17. The extrusion die of claim 16, wherein the first and second metal plates further define two second buffering spaces across the first and second and third cavities, wherein one of the second buffering spaces is located upstream of the first buffering space and downstream of the first and second and third distributing channels; the other of the second buffering spaces is located downstream of the first buffering space and upstream of the exit.
